(19) United States
(12) Patent Application Publication
(10) Pub. No.: US 2025/0244010 A1
(43) Pub. Date: Jul. 31, 2025

(54) Flashlight for handheld drills

(71) Applicant: Jason Wesley Bethards, Granbury, TX (US)

(72) Inventor: Jason Wesley Bethards, Granbury, TX (US)

(21) Appl. No.: 18/445,774

(22) Filed: Jan. 29, 2024

(51) Int. Cl. F21V 33/00; B23B 45/00; F21L 4/00

(52) U.S. Cl. CPC F21V 33/0084; B23B 45/003; F21L 4/005

(57) ABSTRACT

Installing a flashlight on a drill if you need to light up a work place will help people work in safer conditions. This patent solves the problem of where to add accessories like flashlights on a drill. Many different accessories can go on a drill. Adding and removing accessories to a drill should be easy. The flashlight with a mount integrated into the housing is what I am proposing.

### INTRODUCTION

My name is Jason Bethards. I am a U.S. citizen. I reside in Granbury Texas. My residential address is 4943 Peachtree Circle. I would like to install flashlights on hand held drills. I propose a Flashlight that has a quick release mount on it to mate with a drill that has an accessory spot for all accessories.

### DESCRIPTION

Currently there are no flashlights that are able to be connected directly to a drills accessory mount. Working without the proper lighting, conditions can be too tedious and become difficult for workers to perform tasks. It could also lead to incidents in the workplace. Installation of a flashlight that can be attached to the drills accessory mount will provide workers with adequate lighting and set up safety measures to prevent accidents from occurring. Whereas workers are usually forced to carry bulky lighting equipment that require an external support system or putting themselves in danger by using multiple limbs, this flashlight offers an alternative option, acting as a drill accessory that can be easily attached and removed to ensure maximum control and stability for workers without the annoying hassle associated with typical flashlights. Average factory lights used to illuminate the work area are often less powerful, appearing dim and don't provide adequate lighting to ensure precision due to the lack of light that is targeted toward the work region. The flashlight, being attached to the drill to target the drilling region, offers extra lighting making it more powerful and beneficial to workers.

### BRIEF DESCRIPTION OF THE DRAWINGS

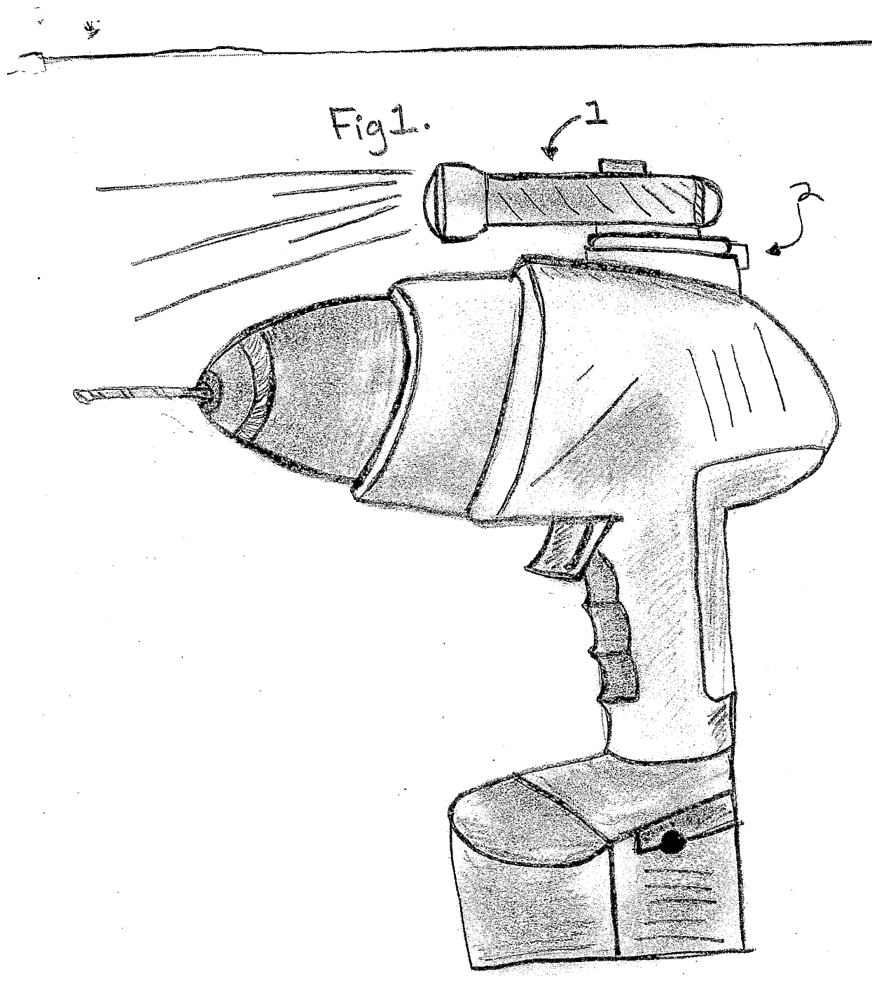

FIG. 1 is a plain view of the flashlight attached to electric hand drill.
1. Flashlight
2. Dislodge button on mount to allow flashlight to easily slide on and off

FIG. 2 is a aerial view of the flashlight.
3.Power Button

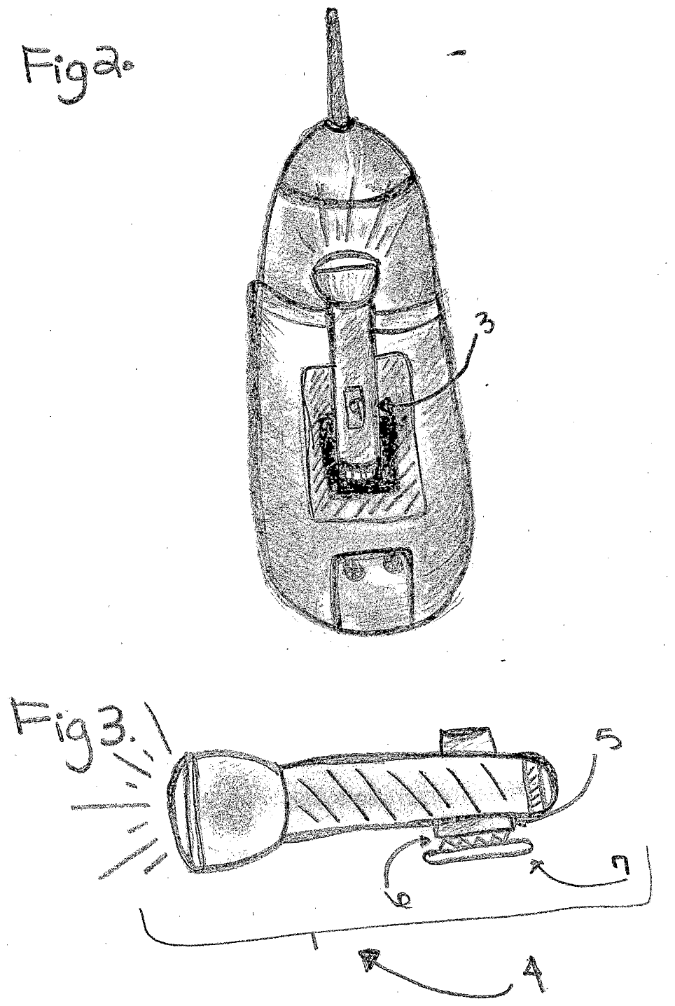

FIG. 3 is a plain view of flashlight in accordance with the invention.
4. Width and height of flashlight in comparison to the drill in accordance with the invention
5.Square element that is attached to the case of the flashlight.
6.Cylindrical element that attaches to the drills accessory mount
7.Spring that allows the square element and cylindrical element to intersect.and locks them in place.

### BACKGROUND

Adding accessories to an electric hand drill will help the building industry. Construction workers and metal workers will benefit from being able to add accessories on drills. Many inventors have added flashlights to drills, they would attach it to bit holders or just fix it to the drill. Instead of trying to find weird spots on a drill to attach accessories to, why not make a spot on the drill to add accessories. Having a flashlight mounted on your drill that will snap on or off, will be nice to see in dark areas of your work area.

### Patent Comparison

The flashlight being tailored to lodge and dislodge onto the base cavity of the drills accessory mount is the most important feature offered by the use of this product. This allows the unit to be easily removed in the case that it is not needed or, other accessories are in use. The Power Tool with light emitting assembly identified under patent number US20110058356A1 also has similar functionality whereas it also provides illumination, but it does not allow for this feature to be replaced with other devices as it is a dual component that acts as one unit and cannot be removed. The light for hand tools under patent number USD859117S1, also provides similar functioning capabilities however the appearance and attachment points are different and there is no indication that this illumination device is made to target the drilling region of the work area specifically. Whereas the flashlight described in this patent is intended for the use of electric hand drills and is not tailored to being used on just any handheld tool. Handheld drills need a specially tailored illumination device in order for construction workers to be precise and accurate as they are performing their tasks. Lack of controlled lighting can lead to mistakes in construction work and can therefore cause bigger problems and make tasks even more challenging. Construction work is done in various conditions, for example workers often work in areas with little to no light sources, in the early hours of the morning before the sun rises, and even after the sun sets. Lack of a reliable and easy to use light source can be seen as an issue for many workers who are often in a position where the light source can cause problems in their jobs or even prevent them from being able to get the job done. This flashlight provides workers with a quick solution and gives them the ability to complete their work with precision and efficiency. The flashlight being portable allows users to reap the benefits of having a hands-free direct light source. The portability of the flashlight also provides workers with more control and flexibility.

### Patent Comparison Continued

The main difference in all the other patents is, this Flashlight will be installed on a mount that is made for accessories only. All other patents that use flashlights on drills attach to existing spots on drills like bit holders. I have seen patents that I described earlier, that has mounted a certain accessory to the drill. The flashlight mount I am proposing will accept other accessories also.

1. A cordless flashlight with a small cylindrical casing being dimensioned and configured fit handheld drills; and

2. a bracket device consisting of a spring clip and two small elements one being square one being cylindrical comprised as dual attachment points allowing users to easily connect the flashlight device to the handheld drill.

3. A flashlight having a
1. power button that allows users to turn flashlight on and off.
2. An elongated cylindrical case being made up of plastics, and rubber.
3. A small bulb that provides illumination
4. Battery operated power source.

4. A flat elongated square element that is attached to the case of the flashlight; and

5. A cylindrical element that can be attached to the drill and integrated into the square element being dimensioned and configured to allowing the two elements to interconnect and securely bind together.
This flashlight will act as an apparatus providing illumination for workers when using handheld drilling equipment.
